(19) United States
(12) Patent Application Publication
(10) Pub. No.: US 2016/0095038 A1
(43) Pub. Date: Mar. 31, 2016

(54) RADIO COMMUNICATION SYSTEM, LOAD SHARING METHOD, AND BASE STATION

(71) Applicant: Hitachi, Ltd., Tokyo (JP)

(72) Inventor: Mikio KUWAHARA, Tokyo (JP)

(21) Appl. No.: 14/855,711

(22) Filed: Sep. 16, 2015

(30) Foreign Application Priority Data
Sep. 29, 2014 (JP) 2014-197794

(51) Int. Cl. H04W 36/22; H04W 36/00; H04W 36/30; H04W 72/04

(52) U.S. Cl. CPC H04W 36/22; H04W 72/0453; H04W 36/0072; H04W 36/30

(57) ABSTRACT

When a frequency band which can be utilized by a radio communication system is divided into multiple partial frequency bands and one or more partial frequency bands are allocated to multiple base stations, each base station reports to a control station information for receiving a signal transmitted by a terminal and a number of connected terminals for every partial frequency band. The control station determines a load of each partial frequency band based on the information received from each base station. Regarding a terminal group that performs communication utilizing the partial frequency band on which the load is generated, the control station delivers information for receiving a signal transmitted by the terminal group to each base station and instructs interference measurement of the terminal group. The control station determines necessity of a handover, a handover destination base station, and a frequency and performs a base station-led handover.

### BACKGROUND OF THE INVENTION

1. Field of the Invention

The present invention relates to a radio communication technology, and particularly to a radio communication technology for performing radio communication service on an airport surface.

2. Description of the Related Art

As a characteristic of radio communication on an airport surface, there are few radio wave shielding objects in an airport and the radio wave easily reaches far. Accordingly, in a case where there is a plurality of radio terminals which perform communication by using the same frequency in the airport, an interference problem is serious.

Further, in a case where frequency reuse is performed, a frequency band which can be used by each base station is narrowed. In a radio communication system, a storage position of a control signal within a radio frame is determined. Under an influence of the frequency band narrowed by the frequency reuse, an uplink control signal becomes particularly susceptible to interference. In order to avoid the interference in the uplink control signal, it is effective to reduce deviation of the number of connected terminals connected to each base station and each divided frequency band and keep load balance. Usually, a handover of the terminal from the one base station to the other base station is performed by a handover request from the radio terminal. In order to hand over the terminal from the base station having a large number of connected terminals to a small number of connected terminals to keep the load balance of the base stations, it is necessary to perform the handover led by the base station.

WO 2005/109689 A discloses an invention that provides a system and a method in which a mobile subscriber station (MSS) performs a fast handover at a request of a base station (BS) in a broadband wireless access (BWA) communication system. In a column of Related Art, a process of handover requested by the BS in IEEE (Institute of Electrical and Electronics Engineers) 802.16e communication system is described based on a standard. WO 2005/109689 A discloses that the handover requested by the BS occurs in a case where the BS is in an overload state and requires load sharing for sharing the BS load with neighboring BSs or in a case of coping with a variation in an uplink state of the MSS (terminal).

### SUMMARY OF THE INVENTION

There are few radio wave shielding objects in an airport. In a case where there is a plurality of radio terminals using the same frequency, an interference problem easily occurs. Particularly, in a case where frequency reuse is performed, interference in an uplink control signal is more serious. In order to solve such an interference problem, it is necessary to keep load balance of the number of terminals among frequencies. An object of the present invention is to provide a method of keeping load balance of the number of terminals among frequencies in a radio communication system that utilizes by dividing a frequency band which can be utilized by the radio communication system into a plurality of frequency bands.

In order to solve the above problem, according to one aspect of the present invention, in a case where a frequency band which can be utilized by the radio communication system is divided into a plurality of partial frequency bands and one or more partial frequency bands are allocated to the plurality of base stations, each of the base stations reports to the control station information for receiving a signal transmitted by a connected terminal and a number of connected terminals for each of the allocated partial frequency band. The control station determines a load of each of the partial frequency band based on the information of the number of connected terminals received from each of the base stations. Regarding the partial frequency band on which the load is generated, the control station delivers information for receiving a signal transmitted by a terminal group that performs communication utilizing the partial frequency band to each of the base stations that performs communication utilizing the partial frequency band and instructs interference measurement of the terminal group. The control station receives an interference measurement result of the terminal group from each of the base stations and determines necessity of a handover, a handover destination base station, and a frequency regarding the terminal group. With respect to the base station connected to the terminal which is determined that the handover is necessary, the control station instructs a base station-led handover to the frequency of the determined base station.

According to the present invention, the interference problem caused by the use of the same frequency by the plurality of radio terminals can be avoided.

### BRIEF DESCRIPTION OF THE DRAWINGS

FIG. 1 is a diagram illustrating an example of an airport structure for describing airport surface communication;

FIG. 2 is a diagram illustrating an example of frequency allocation in one embodiment of the present invention;

FIG. 3 is a diagram describing a configuration of a radio communication system in one embodiment of the present invention;

FIG. 4 is a diagram describing a relation of connection between a terminal and a base station in one embodiment of the present invention;

FIG. 5 is a diagram describing a relation of connection between the terminal and the base station in one embodiment of the present invention;

FIG. 6 is a diagram describing a configuration example of the base station and the terminal in one embodiment of the present invention;

FIG. 7 is a diagram describing a configuration of the base station in one embodiment of the present invention;

FIG. 8 is a sequence diagram describing load balance processing in one embodiment of the present invention; and

FIG. 9 is a flowchart describing the load balance processing in one embodiment of the present invention.

### DESCRIPTION OF THE EMBODIMENT

An embodiment of the present invention will be described below with reference to the accompanying drawings.

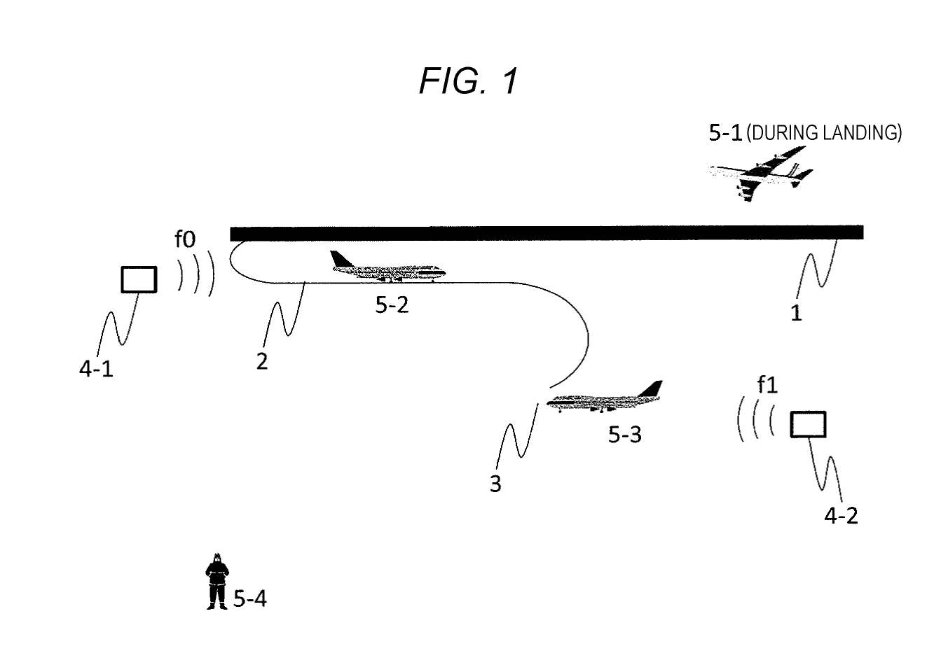

FIG. 1 is a diagram illustrating an example of an airport structure for describing airport surface communication.

The airport surface communication will be described by using the example of the airport structure in FIG. 1.

A thick black line in the center of FIG. 1 indicates a runway 1. When an airplane lands, a terminal mounted on the airplane searches a plurality of frequencies and measures reception field intensity. The terminal finds out a base station transmitting a signal of frequency with the strongest reception field intensity and starts a connection procedure to the base station. In the airport, since there is no obstacle shielding a radio wave in and around the airport, there is no radio wave attenuation by an obstacle, such as ordinary cellular communication, and the radio wave easily reaches far without attenuating. In other words, the radio wave easily gives interference to a distant place.

First, the airplane, on which a terminal 5-1 is mounted, starts to land from a right end of the runway 1 and retreats to a taxing 2 lane near a left end of the runway. After the retreat or immediately before the retreat, the terminal starts airport surface communication. Here, the terminal performs communication with a nearest base station 4-1 (using frequency f0). A terminal 5-2 mounted on the airplane after retreating to the taxing lane continues to move at a relatively fast moving speed (e.g., approximately 70 km/h) during the taxing. Eventually, the airplane stops at a gate 3, and passengers can get on or off the airplane. When the airplane approaches the gate 3, it is desirable that the terminal be connected to a base station 4-2 (using frequency f1) near the gate 3. It is because the base station 4-2 is disposed near the gate 3 for the purpose of realizing the best communication near the gate 3. However, as described above, since the radio wave reaches far in the airport, reception field intensity of a signal from the base station 4-1 is not weakened to a terminal 5-3 as well after the airplane moves near the gate 3. As a result, a handover led by the terminal hardly occurs. On the airport surface, there is a terminal 5-4 used by a maintenance worker or installed in a working vehicle other than the terminals mounted on the airplane.

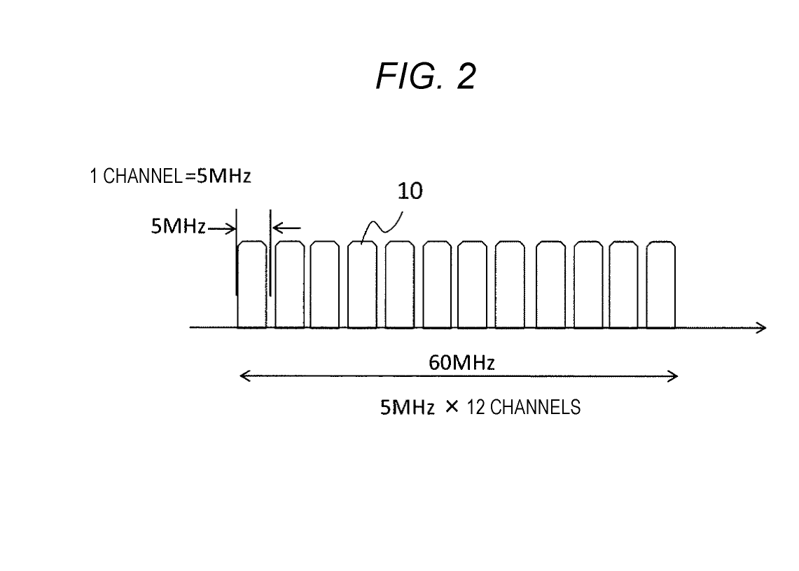

FIG. 2 illustrates an example of frequency allocation in one embodiment of the present invention.

In a case where there is a band of, for example, 60 MHz as an entire radio communication system, a configuration which is used by dividing this band into 12 and lowering a reused rate is considered. Here, “10” indicates one serviceable band (one channel). In a case of FIG. 2, one channel is 5 MHz by dividing 60 MHz into 12.

The airplane landed at the airport makes a connection request to a particular frequency (a frequency allocated to a channel of the base station 4-1 in the example in FIG. 1) among frequencies allocated to a plurality of channels illustrated in FIG. 2 and receives a service at that frequency. As mentioned above, even if the band which can be used is divided into 12 and allocated to the base station as the entire radio communication system, when the number of terminals or the number of base stations to be installed is increased, it is necessary to allocate the same frequency to the plurality of different base stations. This is called “reuse of frequency” or “frequency repetition”. Since a radio wave reaches far on the airport surface, even if the same frequency is allocated to the base stations separated by a great distance, interference easily occurs. Accordingly, it is necessary to grasp the number of terminals utilizing a frequency for each frequency reused and manage the number of terminals. When the number of connected terminals for each frequency cannot be sufficiently managed, an uplink control channel becomes particularly susceptible to serious interference. When the interference occurs in the uplink control channel, the base station cannot receive the control channel and stability of the communication significantly lowers.

In that case, it is necessary to have a mechanism in which the terminal is not concentrated on the specific frequency or the specific base station, i.e., a function of load balance. One of the techniques required to realize the load balance is a procedure of compulsively handing over the terminal to the other base station or the other frequency led by a base station. Regarding this, as described in the Related Art, in the system based on IEEE (The Institute of Electrical and Electronics Engineers, Inc.) 802.16e, for example, the handover procedure led by the base station is defined as the standard. In addition to the base station-led handover procedure, in order to realize the load balance, it is necessary to grasp concentration of the terminal to the frequency as an entire system and to have a technique to perform load sharing as the entire system. In other words, the load balance cannot be realized even if the single base station has interference information. As mentioned above, since there are few radio wave shielding objects in the airport, the interference problem occurs among the plurality of base stations, to which the same frequency is allocated, even if the base stations are separated by a great distance. Accordingly, it is necessary to manage the interference while viewing the entire system. In the following embodiment, a configuration which manages the interference of the entire radio communication system will be described.

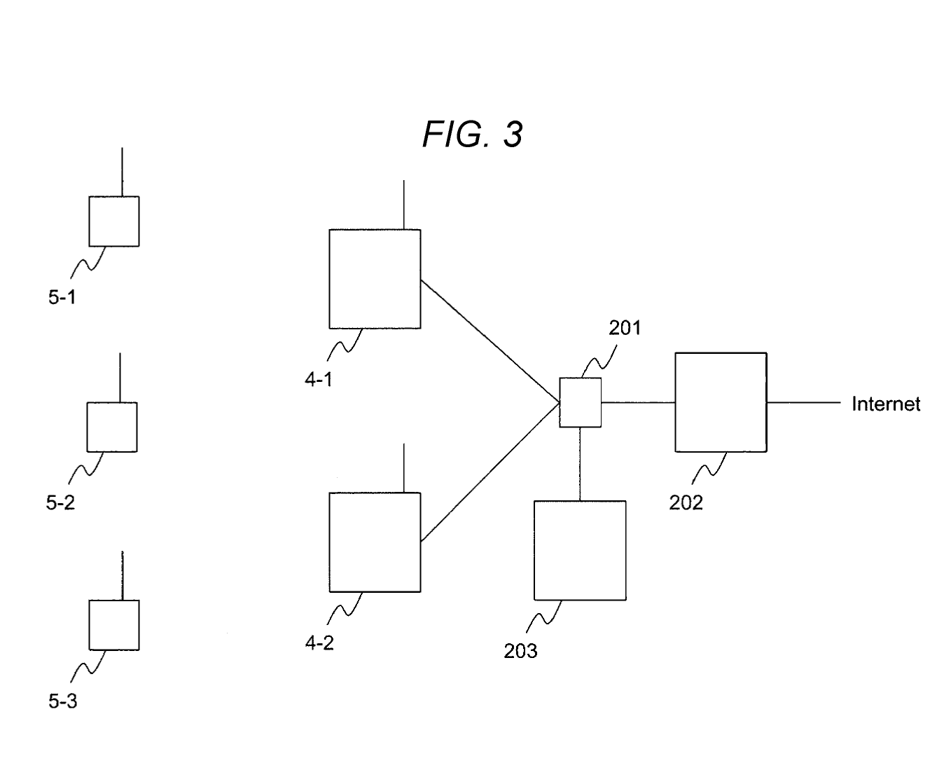

FIG. 3 is a diagram describing a configuration of the radio communication system in one embodiment of the present invention.

A radio communication system illustrated in FIG. 3 includes base stations 4-1, 4-2, terminals 5-1, 5-2, 5-3, an ASN-GW 202 controlling a handover of the terminal, a control station 203 keeping load balance of the base station, and a router switch 201. The base stations 4-1, 4-2 include antennas for radio communication and are connected to the terminals 5-1, 5-2, 5-3 through radio lines. The base stations are connected to the router switch 201, and further, the router switch 201 is connected to the ASN-GW 202 and the control station 203. The ASN-GW 202 is connected to an Internet or a service node, which is not illustrated in the drawing, and provides a service to the terminals.

Each base station receives a signal transmitted by the terminal. In the present embodiment, the base station has a function of receiving a signal transmitted by not only the terminal connected to oneself but also the terminal connected to the other base station. In order to activate this function, it is necessary to have transmission timing or a frequency of the signal transmitted by the terminal connected to the other base station and to have descrambling information in a case where scrambling peculiar to the connection destination base station is started. The control station 203 selects the terminal whose interference should be measured by each base station, transmits information for receiving a signal transmitted by the terminal to the base station requiring this information, and instructs the interference measurement thereto. From the control station 203, each base station receives information for receiving the signal transmitted by the terminal connected to the other base station and receives the signal transmitted by the terminal. Then, a reception power can be measured based on the reception result. In this way, in the present embodiment, each base station can grasp an interference power received from the terminal connected to the other base station. Further, the base station can determine whether the connected terminal can be connected to the other base station. Information on the interference power and the determination result of connection propriety is collected in the control station 203. The control station 203 utilizes the collected information when performing the load balance.

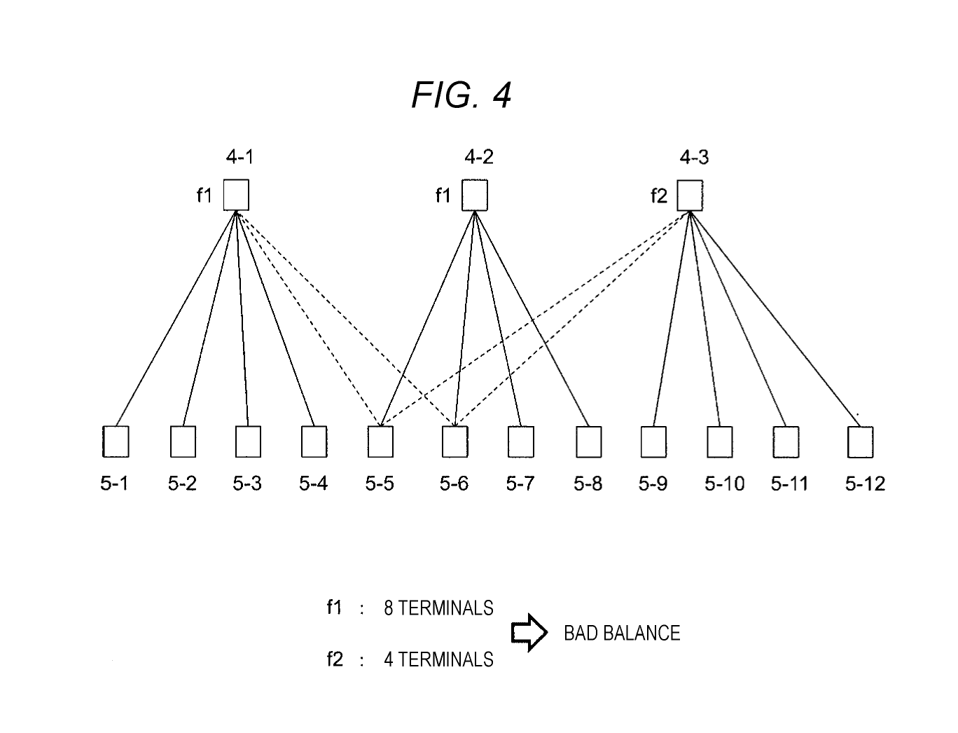

FIG. 4 is a diagram describing a relation of connection between the terminal and the base station in one embodiment of the present invention.

In an example of FIG. 4, the base station 4-1 and the base station 4-2 use the same frequency f1. Further, the base station 4-3 uses a frequency f2 different from that of the base stations 4-1, 4-2. Here, for the sake of ease, illustration is given of a case where each base station transmits only one frequency. However, it is also considered that a system in which each base station simultaneously supports a plurality of frequencies. In a case of such a system as well, essence of the problem and the solution thereto is not changed.

In FIG. 4, 12 terminals are described. The respective terminals are divided into three groups, and exactly four terminals are connected to each of the three base stations. Here, a solid line illustrates that the terminal is connected to the base station. Further, a broken line illustrates a relation that the terminal is capable of receiving a signal transmitted by the base station at the broken line destination with small propagation loss.

For example, the terminal 5-6 is in a situation in which it is connected to the base station 4-2 and is also connectable with the base station 4-1 and the base station 4-3 with small propagation loss. (As described hereinabove, on the airport surface, since there are few radio wave shielding objects and the radio wave reaches far, such a phenomenon is particularly conspicuous.)

Since the number of terminals connected to each base station is the same, it seems that the situation illustrated in FIG. 4 is a balanced situation from a viewpoint of the base station. However, the base station 4-1 and the base station 4-2 use the same frequency f1. Because of this, determining from each frequency, eight terminals are connected to f1 and only four terminals are connected to f2. Accordingly, it cannot be said that the situation illustrated in FIG. 4 is a balanced state. Especially, the terminal 5-5 and the terminal 5-6 are connected to the base station 4-2 and are also in a state capable of receiving a signal from the base station 4-1 with small propagation loss. For the sake of interference management, the base station 4-1 needs to manage six terminals. However, hitherto, the base station cannot analyze the signal transmitted from the terminal connected to the other base station. Further, the base station cannot measure interference by specifying the terminal.

In a system of one embodiment of the present invention, information necessary for receiving information (e.g., CQI (Channel Quality Indicator) information) transmitted by the terminal connected to the other base station is delivered from the control station 203. The information necessary for receiving the signal transmitted by the terminal connected to the other base station includes, for example, transmission timing, a frequency, and a descrambling method. The base station that has received such information from the control station 203 can also receive information transmitted by the terminal connected to the base station other than its own station. This configuration can specify from which terminal the base station in the present embodiment receives interference. The base station reports interference information to the control station 203 based on the specified result. Based on the interference information received from the base station, the control station 203 determines which terminal should be moved to the other frequency or the other base station by a base station-led handover.

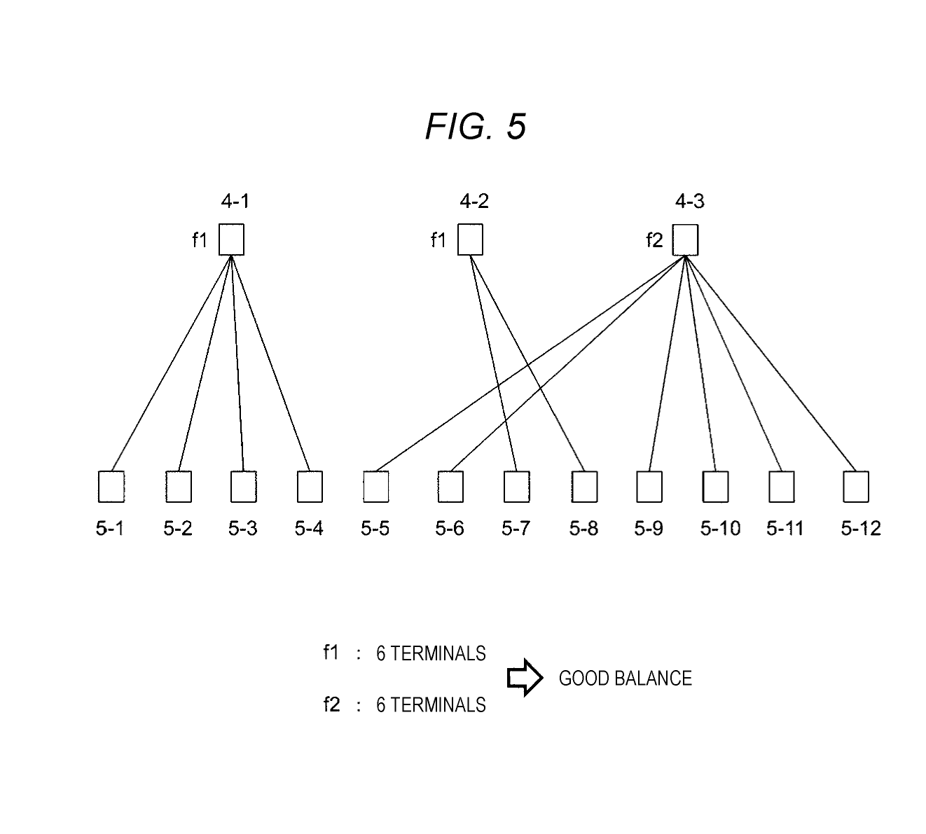

FIG. 5 is a diagram describing a relation of connection between the terminal and the base station in one embodiment of the present invention.

In FIG. 5, each base station performs a base station-led handover based on the determination of the control station 203, and the situation in FIG. 4 is improved.

In FIG. 5, led by the base station, the terminal 5-5 and the terminal 5-6 are handed over from the base station 4-1 to the base station 4-3. As a result of this handover, the frequency utilized of the terminal 5-5 and the terminal 5-6 is changed to f2 which is different from f1. In this changed state, the number of terminals connected to the frequency f1 is six, and the number of terminals connected to the frequency f2 is also six. It can be said that load balance as an entire system is in a good state.

As mentioned above, in order to perform such a load balance, it is required first that each base station in the radio communication system previously transmits to the control station the information necessary for receiving the signal transmitted by the terminal connected to each base station. Alternatively, it is required first that the control station collects and collectively manages the information from each base station periodically or by instructing transmission to each base station. The control station delivers the collectively-managed information to the base station when needed. With this configuration, the base station can collect information, such as CQI, transmitted by the terminal connected to the other base station.

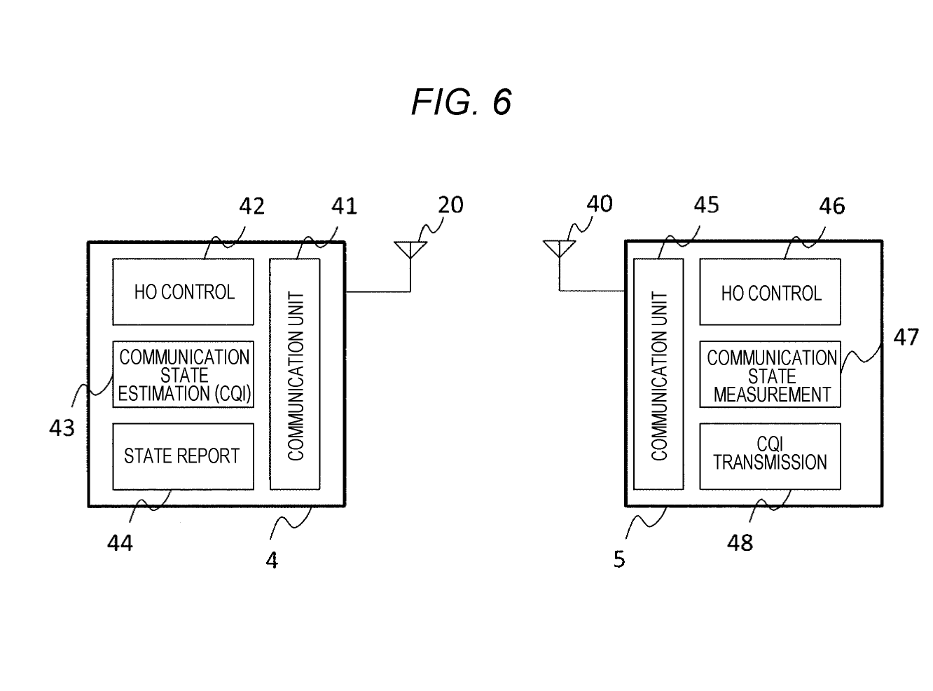

FIG. 6 is a diagram describing a configuration example of the base station and the terminal in one embodiment of the present invention.

In FIG. 6, a base station 4 has a communication unit 41 connected to an antenna 20. The communication unit 41 includes a modem and an RF (Radio Frequency) circuit, and communicates with a terminal 5 by transmitting and receiving a radio wave via the antenna 20. The terminal side also includes an antenna 40 and a communication unit 45 opposed to the base station 4. A handover control (HO control) part of the terminal 5 controls handover processing activated by the terminal or handover processing activated based on a handover instruction from the base station 4.

The communication unit 41 of the base station is connected to a communication state estimation means 43. The communication unit 45 on the terminal side is connected to a communication state measurement means 47 and a CQI transmission means 48. An HO control part of the base station 4 controls handover processing activated by a handover request from the terminal 5 or handover processing of the base station 4 activated based on a handover instruction from the control station.

The communication state measurement means 47 of the terminal 5 receives a reference signal, a pilot signal, or the like transmitted by the base station and measures a communication state. The CQI transmission means of the terminal 5 reports the communication state measured by the communication state measurement means 47 to the base station 4. The base station 4 receives a CQI signal reported by the terminal. At this time, by delivered information from the control station 203, not only the base station connected to the terminal, but also the other base station receives the CQI signal transmitted by the terminal to the base station connected to the terminal. When receiving the signal from the terminal, the other base station measures signal intensity and measures interference power from the terminal. The measured interference power is reported from a state reporting means 44 to the control station.

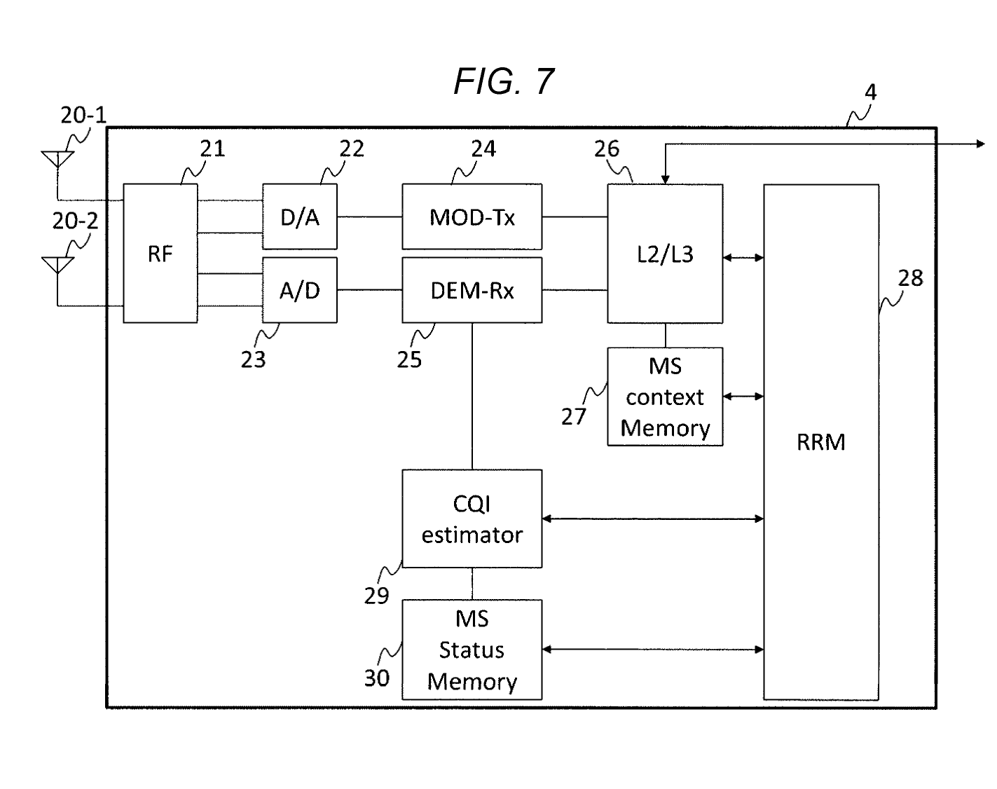

FIG. 7 is a diagram describing a configuration of the base station in one embodiment of the present invention.

FIG. 7 is an explanatory diagram in which the configuration of the base station 4 illustrated in FIG. 6 is further detailed.

The base station includes two antennas 20-1, 20-2. The antennas are connected to an RF circuit 21. The RF circuit converts the signal received by the antenna into a baseband, amplifies a transmission signal by converting from a baseband signal to an RF signal, and transmits from the antenna. A transmission side of the RF circuit is connected to a D/A (Digital/Analog) converter 22, and a reception side thereof is connected to an A/D (Analog/Digital) converter 23. The D/A converter 22 and the A/D converter 23 perform conversion of an analog signal and a digital signal of a transmission/reception signal. A transmission modem part 24 converts a signal generated by an L2 (Layer2)/L3 (Layer3) part 26 into a modulation signal which can be transmitted by radio. Further, a reception modem part (DEM-Rx) 25 takes out the pilot signal included in the reception signal, detects and decodes a data signal after estimating a quality of the propagation path, and takes out the information.

A radio management part (RRM part: Remote Radio Module) 28 acquires, from the control station illustrated in FIG. 1, information (specifically, transmission timing, a frequency, a descrambling method) for receiving the CQI signal that is transmitted by the terminal connected to the other base station. The RRM part instructs reception processing based on the received information to the CQI reception part 29. The CQI reception part receives the CQI signal transmitted by the object terminal and acquires information, such as signal intensity thereof. The base station temporarily stores the obtained information, such as the signal intensity, in a terminal status memory 30. After that, the RRM part reports the information to the control station.

The reception modem part (DEM-Rx) 25 transmits the received data to the L2/L3 part 26. The L2/L3 part separates the data received from the reception modem part 25 into control information and user data, and transmits the user data to a network side. The control information is transmitted to the RRM part 28 and used for radio management. Particularly, information, such as an ID of the terminal during the connection, is stored in a context memory 27.

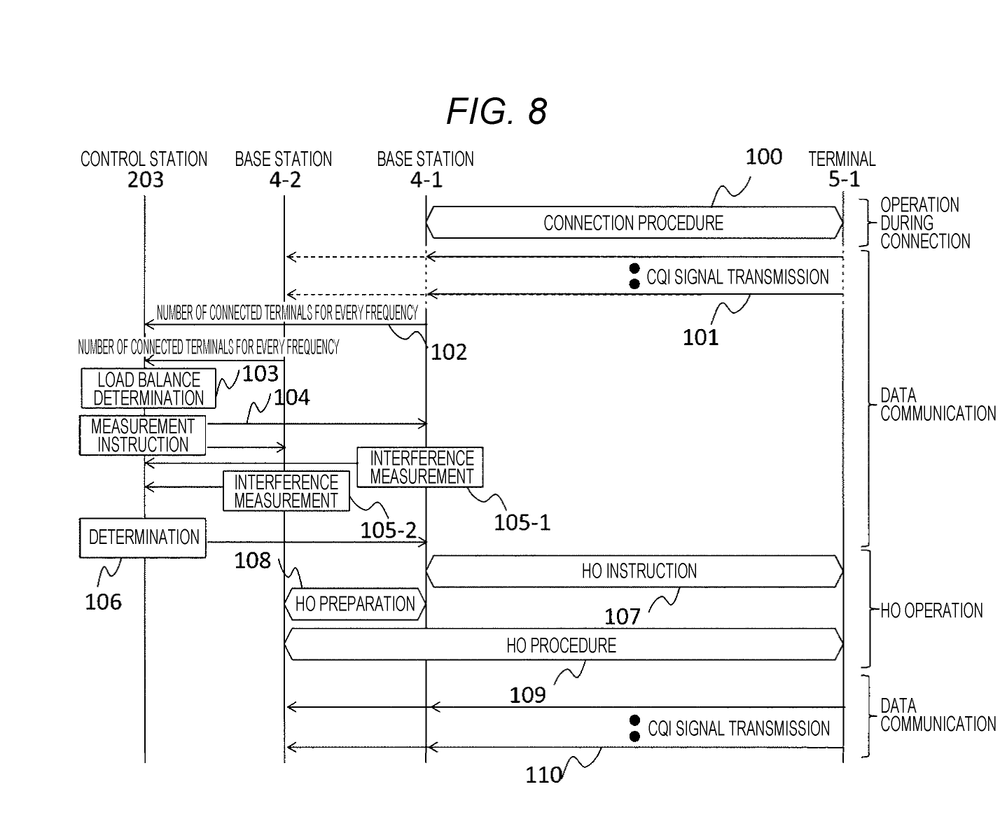

Further, the RRM part executes a base station-led handover sequence (see FIG. 8) according to an instruction from the control station.

In FIG. 7, the L2/L3 part and the RRM part are realized by a CPU. Consequently, each block is embodied as a subroutine of a program.

FIG. 8 is a sequence diagram describing load balance processing in one embodiment of the present invention.

FIG. 8 is a communication sequence among the terminal 5-1, the base station 4-1 (the handover original base station), the base station 4-2 (the handover destination base station), and the control station 203.

First, in order to obtain connection with the base station 4-1, the terminal 5-1 secures a communication path with the base station 4-1 according to a connection procedure 100. After the communication path is secured, the terminal 5-1 and the base station 4-1 start data communication. The data communication includes uplink signal communication. The uplink signal includes information, such as the CQI signal, periodically transmitted during the communication (101). The base station 4-1 performs processing against fluctuations in the quality of the propagation path, such as link adaptation, by using the CQI signal.

The control station 203 causes the respective base stations (4-1, 4-2) to report the number of connected terminals for every frequency (102). The control station 203 determines load balance based on a value in which the reported number of connected terminals is added up for every frequency (103). If it is determined that the load balance is lost, an interference measurement instruction about the terminal which is connected at a frequency considered to have a high load is transmitted to the respective base stations (104). This interference measurement instruction includes information for receiving the CQI of the object terminal. Each base station receives the CQI signal at the CQI reception part and measures the power. Each base station reports a measured result to the control station 203 (105-1, 105-2). Based on the reported values about the plurality of terminals, the control station determines a handover destination frequency or a handover destination base station, and instructs a base station-led handover to the base station with which the terminal of the handover object is currently connected (106). The base station 4-1 with which the terminal of the handover object is currently connected transmits a handover instruction (107) to the terminal. The message includes information of the handover destination base station 4-2. Further, the base station 4-1 transmits a HO (Hand Over) preparation message (108) to the base station 4-2 to inform that there is a handover of the terminal. The base station 4-2 which has received this message executes the handover procedure (109) with the terminal. When the handover is completed, the terminal 5-1 is shifted to a communication state (110) with the handover destination base station 4-2.

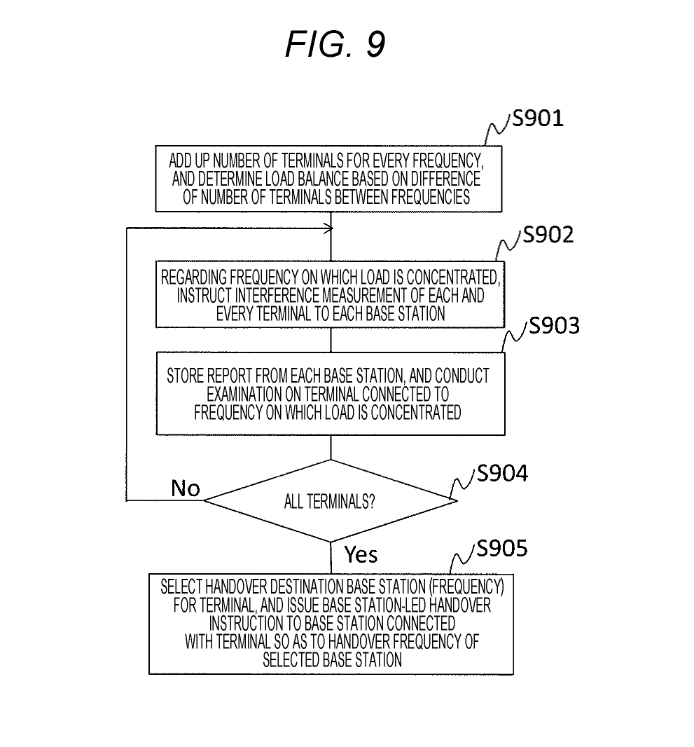

FIG. 9 is a flowchart describing the load balance processing in one embodiment of the present invention.

FIG. 9 illustrates a flow of the control station 203.

The control station causes each base station to report the number of connected terminals for every frequency periodically or by sending a report instruction from the control station. For example, the base station connected to the plurality of terminals by using the plurality of frequencies reports to the control station the number of connected terminals for every frequency. The control station adds up the number of connected terminals for every frequency, and monitors a difference of number of connected terminals between the frequencies. For example, when the difference exceeding a threshold value is generated, the control station determines that the load balance is needed between the frequencies and starts a load balance procedure (S901). First, regarding the frequency on which the load is concentrated, interference measurement of each and every terminal is instructed to each base station (S902). The base station that has received this instruction is in a state that has received the instruction (104) illustrated in FIG. 8, and reports the interference measurement result. The control station stores the report from each base station, and conducts examination on all the terminals connected to the frequency on which the load is concentrated (S903). When information of all the terminals is collected (S904), the control station selects the handover destination base station of the terminal connected to the frequency on which the load is concentrated. Specifically, the control station selects the base station which has a small load, uses the other frequency, and has small propagation loss with the terminal connected to the frequency on which the load is concentrated. The control station issues a base station-led handover instruction to the base station connected to the terminal so as to hand over the frequency of the selected base station (S905).

In the above-described solution, the control station can perform the load balance to the appropriate frequency after grasping the utilization situation of every frequency in the entire system.

Further, especially, since the interference state of the uplink control signal can be grasped, reduction of the communication quality caused by a reception defect of the control signal can be effectively prevented. Accordingly, effective use of a frequency resource can be realized.

What is claimed is:

1. A radio communication system having at least a plurality of base stations and a control station controlling the plurality of base stations, comprising:
in a case where a frequency band which can be utilized by the radio communication system is divided into a plurality of partial frequency bands and one or more partial frequency bands are allocated to the plurality of base stations,
each of the base stations reporting to the control station information for receiving a signal transmitted by a connected terminal and a number of connected terminals for each of the allocated partial frequency band;
the control station determining a load of each of the partial frequency band based on the information of the number of connected terminals received from each of the base stations;
regarding the partial frequency band on which the load is generated, the control station delivering information for receiving a signal transmitted by a terminal group that performs communication utilizing the partial frequency band to each of the base stations that performs communication utilizing the partial frequency band and instructing interference measurement of the terminal group;
the control station receiving an interference measurement result of the terminal group from each of the base stations and determining necessity of a handover, a handover destination base station, and a frequency regarding the terminal group; and
with respect to the base station connected to the terminal which is determined that the handover is necessary, the control station instructing a base station-led handover to the frequency of the determined base station.

2. The radio communication system according to claim 1, wherein
the plurality of base stations reports to the control station the information for receiving a signal transmitted by the connected terminal and the number of connected terminals for each allocated partial frequency band periodically or according to the instruction from the control station.

3. The radio communication system according to claim 1, wherein
the information for receiving the signal transmitted by the terminal is transmission timing, a frequency, and a descrambling method for receiving a CQI signal transmitted by the terminal, and
the interference measurement of the terminal group is power measurement of the CQI signal transmitted by a first terminal group.

4. A load sharing method in a radio communication system having at least a plurality of base stations and a control station controlling the plurality of base stations, comprising:
in a case where a frequency band which can be utilized by the radio communication system is divided into a plurality of partial frequency bands and one or more partial frequency bands are allocated to the plurality of base stations,
each of the base stations reporting to the control station information for receiving a signal transmitted by a connected terminal and a number of connected terminals for each of the allocated partial frequency band;
the control station determining a load of each of the partial frequency band based on the information of the number of connected terminals received from each of the base stations;
regarding the partial frequency band on which the load is generated, the control station delivering information for receiving a signal transmitted by a terminal group that performs communication utilizing the partial frequency band to each of the base stations that performs communication utilizing the partial frequency band and instructing interference measurement of the terminal group;
the control station receiving an interference measurement result of the terminal group from each of the base stations and determining necessity of a handover, a handover destination base station, and a frequency regarding the terminal group; and
with respect to the base station connected to the terminal which is determined that the handover is necessary, the control station instructing a base station-led handover to the frequency of the determined base station.

5. The load sharing method according to claim 4, wherein
the plurality of base stations reports to the control station the information for receiving a signal transmitted by the connected terminal and the number of connected terminals for each allocated partial frequency band periodically or according to the instruction from the control station.

6. The load sharing method according to claim 4, wherein
the information for receiving the signal transmitted by the terminal is transmission timing, a frequency, and a descrambling method for receiving a CQI signal transmitted by the terminal, and
the interference measurement of the terminal group is power measurement of the CQI signal transmitted by the terminal group.

7. A base station which performs radio communication with a terminal by dividing a frequency band which can be utilized by a radio communication system into a plurality of partial frequency bands and utilizing one or more partial frequency bands, comprising:
reporting to a host device information for receiving a signal transmitted by a connected terminal and a number of connected terminals for each of the allocated partial frequency band;
when the base station receives from the host device information for receiving a signal transmitted by a first terminal which is not connected to itself and which transmits a signal from the one or more partial frequency bands utilized by itself and an interference measurement instruction of the first terminal, receiving the signal transmitted by the first terminal, measuring interference given by the first terminal to itself, and reporting the interference to the host device; and
based on a handover instruction from the host device, performing a base station-led handover of the first terminal.

8. The base station according to claim 7, wherein
the base station reports to the host device the information for receiving a signal transmitted by the connected terminal and the number of connected terminals for each allocated partial frequency band periodically or according to the instruction from the host device.

9. The base station according to claim 7, wherein
the information for receiving the signal transmitted by the terminal is transmission timing, a frequency, and a descrambling method for receiving a CQI signal transmitted by the terminal, and
the interference measurement of the first terminal is power measurement of the CQI signal transmitted by the first terminal.
